(19) United States
(12) Patent Application Publication
(10) Pub. No.: US 2026/0320677 A1
(43) Pub. Date: Oct. 15, 2026

(54) RECORDING MEDIUM AND INFORMATION PROCESSING SYSTEM

(71) Applicant: Decoo, Inc., Tokyo (JP)

(72) Inventor: Taikou YAMADA, Tokyo (JP)

(21) Appl. No.: 19/179,210

(22) Filed: Apr. 15, 2025

(51) Int. Cl. G06Q 40/02; G06F 3/0481; G06Q 20/36

(52) U.S. Cl. CPC G06Q 40/026; G06F 3/0481; G06Q 20/36

(57) ABSTRACT

A non-transitory computer-readable recording medium has stored therein a program. The program causes a computer to perform acquiring, through a wallet application used by a user and configured to manage a non-fungible token, information on the non-fungible token associated with a wallet address of the user; determining whether a predetermined condition is satisfied based on the acquired information on the non-fungible token; and changing a user interface of the wallet application to a user interface corresponding to the non-fungible token according to an operation of the user in response to determining that the predetermined condition is satisfied.

### CROSS-REFERENCE TO RELATED APPLICATIONS

This patent application is based on Japanese Patent Application No. 2023-182577 filed on Oct. 24, 2023, the entire contents of which are incorporated herein by reference.

### TECHNICAL FIELD

The present disclosure relates to a recording medium, an information processing system, and an information processing method.

### BACKGROUND

In the related art, there is an information processing system described in Patent Document 1. In the information processing system, a theme that can be used to change a user interface of an application can be set. When the information processing system described in Patent Document 1 acquires geographic information related to the theme being set, the acquired geographic information is preferentially displayed on a map.

### RELATED ART DOCUMENT

### Patent Document

[Patent Document 1] Japanese Laid-open Patent Application Publication No. 2022-33114

### SUMMARY

According to one embodiment of the present disclosure, there is a provision of a non-transitory computer-readable recording medium having stored therein a program for causing a computer to perform acquiring, through a wallet application used by a user and configured to manage a non-fungible token, information on the non-fungible token associated with a wallet address of the user; determining whether a predetermined condition is satisfied based on the acquired information on the non-fungible token; and changing a user interface of the wallet application to a user interface corresponding to the non-fungible token according to an operation of the user in response to determining that the predetermined condition is satisfied.

### BRIEF DESCRIPTION OF THE DRAWINGS

FIG. 1 is a block diagram illustrating a schematic configuration of an information processing system of a first embodiment;

FIG. 2 is a diagram schematically illustrating an example of a data structure of an NFT of the first embodiment;

FIG. 3 is a block diagram illustrating a schematic configuration of a server device of the first embodiment;

FIG. 4 is a diagram schematically illustrating an example of NFT possession information stored in a user database of the first embodiment;

FIG. 5 is a diagram schematically illustrating an example of information stored in a theme database of the first embodiment;

FIG. 6 is a flowchart illustrating an example of a process performed by a theme management unit of the first embodiment;

FIGS. 7A and 7B are diagrams schematically illustrating examples of selectable theme information of the first embodiment;

FIG. 8 is a block diagram illustrating a schematic configuration of a terminal device of the first embodiment;

FIG. 9 is a diagram illustrating an example of a screen displayed on the terminal device of the first embodiment;

FIG. 10 is a diagram illustrating an example of the screen displayed on the terminal device of the first embodiment;

FIG. 11 is a sequence chart illustrating an operation example of an information processing system of the first embodiment;

FIG. 12 is a block diagram illustrating a schematic configuration of a computer of the first embodiment;

FIG. 13 is a diagram schematically illustrating an example of information stored in a theme database of a modified example of the first embodiment;

FIG. 14 is a block diagram illustrating a schematic configuration of an information processing system of a second embodiment; and

FIG. 15 is a diagram schematically illustrating an example of a data structure of an NFT of the second embodiment.

### DETAILED DESCRIPTION OF EMBODIMENTS

Digital contents, such as digital art and music data, may be associated with non-fungible tokens (NFTs) that can be created on a blockchain. By associating NFTs with digital contents, it is possible to assert the possession of digital contents to a third party. In the information processing system described in Patent Document 1, a user interface of an application is not changed even when the user possesses such an NFT, and thus there is a scope for improvement.

The program for solving the above-described problem causes a computer to acquire information on a non-fungible token associated with a wallet address of a user, and changes an available user interface of an application to a user interface corresponding to the non-fungible token based on the acquired information on the non-fungible token.

An information processing system for solving the above-described problem includes an information acquisition unit and a change unit. The information acquisition unit acquires information on a non-fungible token associated with a wallet address of a user. The change unit changes an available user interface of an application to a user interface corresponding to the non-fungible token associated with the wallet address.

In an information processing method for solving the above-described problem, a computer acquires information on a non-fungible token associated with a wallet address of a user, and changes an available user interface of an application to a user interface corresponding to the non-fungible token associated with the wallet address.

According to this configuration, when the user possesses a predetermined non-fungible token, an available user interface of an application can be changed to a user interface corresponding to the predetermined non-fungible token owned by the user. Therefore, the user interface of the application can be more appropriately changed based on the non-fungible token.

### Effect of the Invention

According to the recording medium, the information processing system, and the information processing method of the present disclosure, a user interface of an application can be more appropriately changed based on a non-fungible token.

Embodiments of the recording medium, the information processing system, and the information processing method will be described below with reference to the drawings. In order to facilitate understanding of the description, the same reference symbols will be assigned to the same components in the drawings as much as possible, and duplicate descriptions will be omitted.

### First Embodiment

First, an overview of the information processing system of the present embodiment will be described. (Overview of Information Processing System)

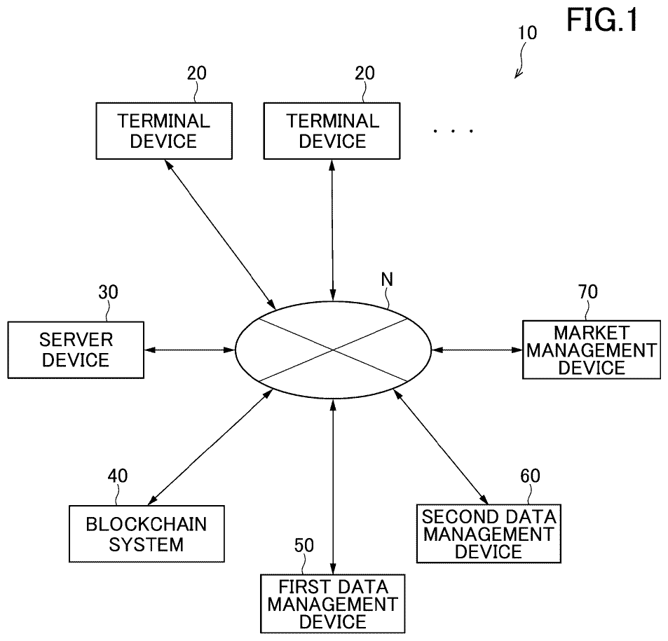

When a user possesses a non-fungible token (NFT) associated with a predetermined digital content, an information processing system 10 of the present embodiment illustrated in FIG. 1 can change a theme of a user interface (UI) of an application used by the user to a theme of a UI corresponding to the NFT owned by the user.

In the present embodiment, a case where the application used by the user is a wallet application will be described as an example. The wallet application is an application that can centrally manage the NFT, a virtual currency, and the like owned by the user, or trade NFTs, virtual currencies, and the like with another user. In the following, change of the theme of the UI of the wallet application is also referred to as “theme change”.

The NFT is a type of encrypted token, and is a token that cannot be replaced by any other token. Therefore, when a user possesses an NFT, the user can assert to a third party that the user is an owner of a target digital content associated with the NFT. In the present embodiment, a case where the NFT is issued and traded by storing data such as a hash value that can guarantee the correspondence between the NFT and the digital content in what is called a blockchain will be described as an example. Here, the technology used to issue and trade the NFT is not limited to the blockchain. The digital content associated with the NFT is digital art, video data, music data, text data, items in games, and the like.

Here, a virtual currency is classified as a fungible token (FT) that can be replaced by another token if the amount is the same.

### (Schematic Structure of Information Processing System)

Next, a schematic structure of the information processing system 10 of the present embodiment will be described.

As illustrated in FIG. 1, the information processing system 10 includes multiple terminal devices 20 and a server device 30. These devices are communicably connected to each other via a communication network N. The terminal devices 20 and the server device 30 are communicably connected to a blockchain system 40, a first data management device 50, a second data management device 60, and a market management device 70 via the communication network N.

The terminal devices 20 are respectively owned by multiple users who use the information processing system 10. The wallet application is installed in the terminal device 20. By operating the wallet application in the terminal device 20, the user can check crypto assets, such as the NFT and the virtual currency owned by the user, and can trade the crypto assets, such as the NFT and the virtual currency, with another user.

The server device 30 manages the information on the NFT and the virtual currency for each of the wallets of multiple users. The wallet of each of the users is managed in association with the account of the user. Additionally, the server device 30 transmits, to the terminal device 20, information on a theme corresponding to the NFT owned by the user, so that the theme of the wallet application can be changed.

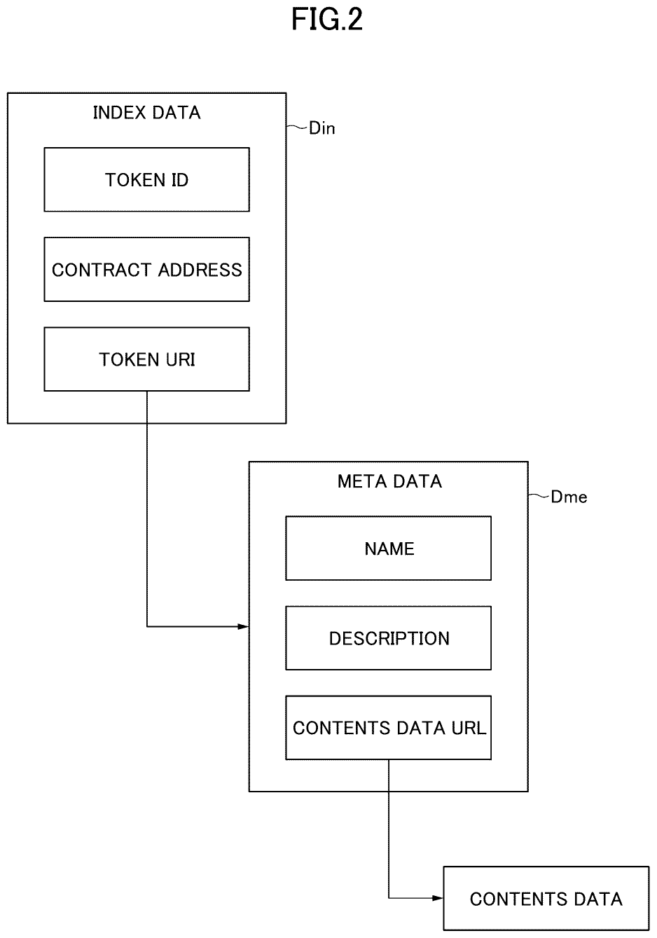

The information included in the NFT is stored in the blockchain system 40 and the first data management device 50. FIG. 2 schematically illustrates an example of a data structure of the NFT. As illustrated in FIG. 2, the NFT includes, for example, index data Din and metadata Dme.

The index data Din includes a token ID, a contract address, a token uniform resource identifier (URI), and the like. The token ID is an identifier that can uniquely identify a token. The contract address is an address on the blockchain where the NFT is stored. The token URI is information indicating a storage location of the metadata. The token URI is, for example, a URL of the metadata.

The metadata Dme includes a name, a description, a URL of content data, and the like. The name indicates the name of the NFT. For example, if content data associated with the NFT is digital art, a name of the digital art is used as the name of the NFT. The description is an explanation of the NFT. For example, when the content data associated with the NFT is digital art, explanation of the digital art is used as the description. The URL of the content data is information indicating a storage location of the data of the digital content associated with the NFT. In the following, the data of the digital content is also referred to as the “content data”.

In the information processing system 10, among the information on the NFT illustrated in FIG. 2, the index data Din is stored on the blockchain. Additionally, among the information on the NFT illustrated in FIG. 2, the metadata Dme is stored in the first data management device 50. As described, in the present embodiment, a case where the index data Din is on-chain data and the metadata Dme is off-chain data is exemplified, but both the index data Din and the metadata Dme may be on-chain data, that is, may be stored on the blockchain.

The blockchain system 40 illustrated in FIG. 1 is a system for constructing a blockchain. The blockchain system 40 is used to issue and trade FT, such as the virtual currency, and to issue and trade the NFT. The blockchain system 40 includes multiple nodes, and distributes and manages data related to FT and NFT transactions in multiple blocks. The multiple blocks are sequentially stored as a chain in the blockchain system 40. Each of the blocks includes transaction data, a hash value, and the like. The transaction data is data related to a transaction history of FT and NFT. The transaction data includes a wallet address of a purchaser, a wallet address of a seller, token information on the FT or the NFT for which the transaction has been conducted, the paid amount of the virtual currency, the date and time of the transaction, and the like. The hash value is information calculated based on data stored in a previous block, and is used to ensure the consistency of each of the blocks. The blockchain system 40 manages data related to the FT and NFT transactions in multiple blocks to ensure the accuracy and tamper-proofness of the data related to the FT and NFT.

The second data management device 60 manages the content data associated with the NFT. The content data managed by the second data management device 60 can be referenced by designating a location where the data is stored. The location where the data is stored is information called, for example, a uniform resource locator (URL), an address, a file path, or the like. In the following, a case where the location where the data is stored is designated by the URL will be described as an example.

The market management device 70 performs a process related to various transactions of the NFT, the virtual currency, and the like. The market management device 70 is, for example, a server device configured to provide a marketplace for the NFT and the virtual currency. The market management device 70 performs the processes related to transactions of the NFT, the virtual currency, and the like based on a user's operation on the wallet application in the terminal device 20. For example, when the user performs an operation to purchase an NFT in the wallet application, an NFT purchase request is transmitted from the terminal device 20 to the market management device 70 via the wallet application. The market management device 70 performs an NFT purchase process based on receiving the NFT purchase request from the terminal device 20. Specifically, the market management device 70 generates transaction data related to the purchase of the NFT, and requests the blockchain system 40 to register the generated transaction data. The transaction data is transmitted to each of the nodes of the blockchain system 40, and is registered in a new block. In such a way, the market management device 70 assigns the purchased NFT to the wallet of the user, in other words, associates the purchased NFT with the wallet address of the user. In such a way, the wallet application of the present embodiment can cooperate with the market management device 70, in other words, can cooperate with the marketplace.

### (Configuration of Server Device)

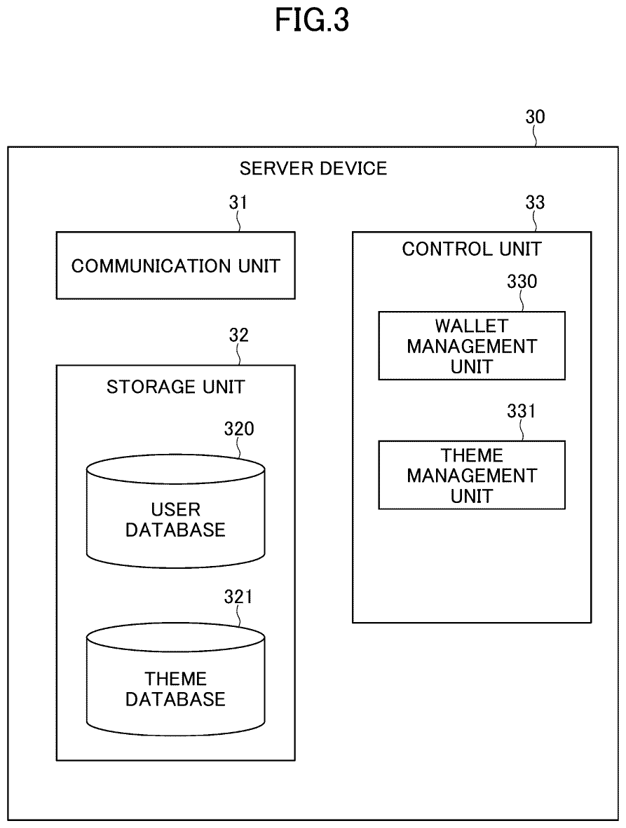

Next, a configuration of the server device 30 will be described. As illustrated in FIG. 3, the server device 30 includes a communication unit 31, a storage unit 32, and a control unit 33. The communication unit 31 performs various communications with the terminal device 20, the blockchain system 40, the first data management device 50, the second data management device 60, and the market management device 70 via the communication network N illustrated in FIG. 1. For example, the communication unit 31 receives information on the operation performed by the user on the wallet application from the terminal device 20. Furthermore, the communication unit 31 transmits, to the terminal device 20, the information on the theme corresponding to the NFT owned by the user. Additionally, the communication unit 31 can acquire the index data Din, the metadata Dme, and the content data of the NFT from the blockchain system 40, the first data management device 50, and the second data management device 60.

The storage unit 32 stores various types of information held by the server device 30. For example, the storage unit 32 stores various types of program data for operating the server device 30. Additionally, the storage unit 32 stores a user database 320 and a theme database 321.

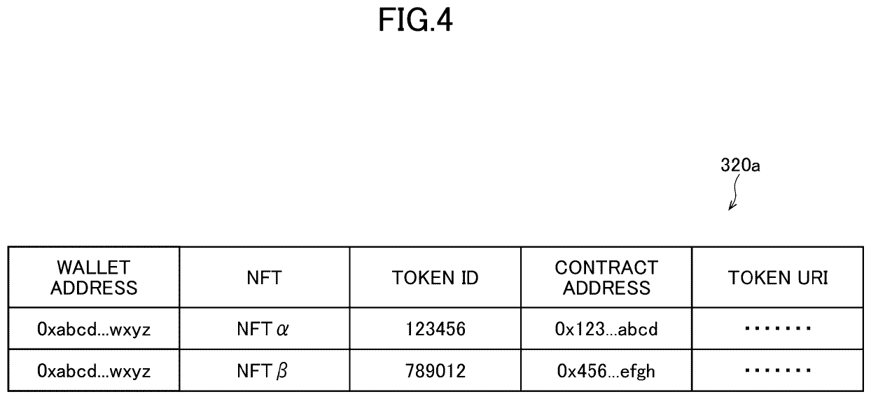

The user database 320 stores a user ID, a wallet address, and possession information associated with each of multiple users using the wallet application. The user ID is an identifier that can uniquely identify each of the users. The wallet address indicates the address of the wallet of the user and is used for trading the NFT, the virtual currency, and the like on the blockchain. The possession information is information on the NFT, the virtual currency, and the like owned by the user. The possession information is created based on information acquired from the blockchain system 40 by the communication unit 31. Therefore, the NFT possession information includes information included in the index data of the NFT owned by the user, such as the token ID, the contract address, and the token URI of the NFT. For example, when the user possesses two NFTs α and β, the user database 320 stores a token ID, a contract address, a token URI, and the like corresponding to each of the NFTs α and β as NFT possession information 320a of the user, as illustrated in FIG. 4. Although each user has a single wallet address for managing multiple NFTs as in the example illustrated in FIG. 4, they may have multiple wallet addresses. The wallet address and the possession information are associated and stored in the user database 320, and thus the NFT owned by the user is associated with the wallet address of the user.

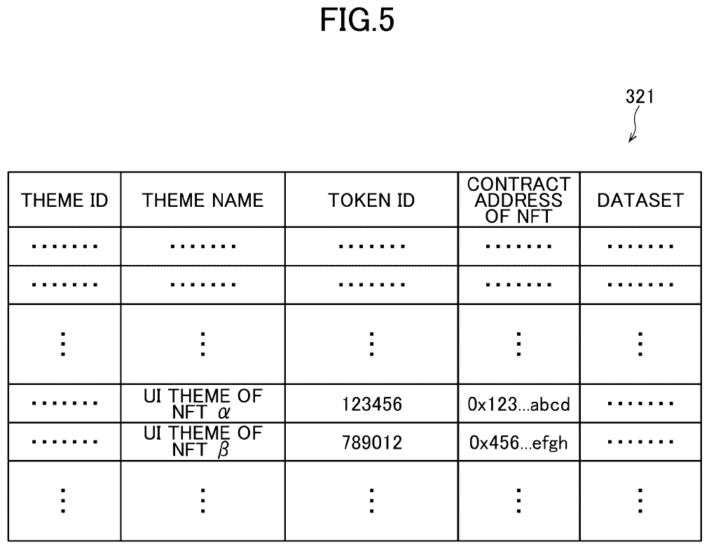

The theme database 321 illustrated in FIG. 3 stores multiple selection themes that can change the theme of the wallet application. FIG. 5 schematically illustrates the information stored in the theme database 321. As illustrated in FIG. 5, the theme database 321 stores a theme ID, a theme name, the contract address of the NFT, the token ID, and a dataset in association with one another. The theme ID is an identifier that can uniquely identify each of the themes. The contract address and the token ID of the NFT are the same as the information included in the index data Din of the NFT. The dataset includes various types of data for changing the theme of the wallet application. The dataset includes, for example, font information, layout information, image data, image data arrangement information, color palette information, and the like.

Here, as illustrated in FIG. 5, in the information processing system 10 of the present embodiment, one theme dataset is associated with a combination of one contract address and one token ID. Alternatively, for example, regardless of the value of the token ID, one theme dataset may be associated with one contract address.

As illustrated in FIG. 3, the control unit 33 controls the server device 30. The control unit 33 includes a wallet management unit 330 and a theme management unit 331 as a functional configuration realized by executing the program data stored in the storage unit 32. The wallet management unit 330 manages the possession information on the NFT and the virtual currency registered on the blockchain for each of multiple users. For example, the wallet management unit 330 connects to the blockchain system 40 in response to the occurrence of the transaction. Additionally, the wallet management unit 330 may connect to the blockchain system 40 in response to the user performing an operation to check owned assets on the wallet application. Furthermore, the wallet management unit 330 may connect to the blockchain system 40 at a predetermined cycle. When connecting to the blockchain system 40, the wallet management unit 330 acquires the information on the NFT, the virtual currency, and the like registered in the blockchain, and stores the acquired information in the user database 320.

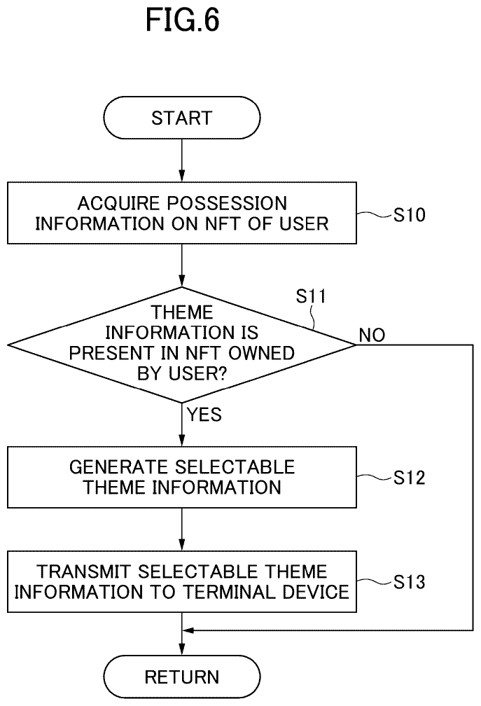

The theme management unit 331 transmits, to the terminal device 20, selectable theme information including information on a theme selectable on the wallet application for each of multiple users. FIG. 6 illustrates an example of a procedure of a selectable theme information transmission process performed by the theme management unit 331. Here, the process illustrated in FIG. 6 is repeatedly performed by the theme management unit 331 at a predetermined cycle.

As illustrated in FIG. 6, the theme management unit 331 first acquires, from the user database 320, possession information on all NFTs owned by the user, that is, possession information on all NFTs associated with the wallet address of the user (step S10). As described, the theme management unit 331 of the present embodiment is an example of an information acquisition unit configured to acquire information on the NFT associated with the wallet address of the user. Subsequently, the theme management unit 331 determines whether theme information is present in the NFT owned by the user (step S11). Specifically, in the processing of step S11, the theme management unit 331 determines whether a combination of the contract address and the token ID of the NFT owned by the user matches the combination of the contract address and the token ID registered in the theme database 321. In the present embodiment, the condition that the combination of the contract address and the token ID of the NFT owned by the user matches the combination of the contract address and the token ID registered in the theme database 321 is an example of a predetermined condition. Additionally, the theme management unit 331 can identify the NFT owned by the user based on at least one of the ID or a collection name of the NFT associated with the wallet address of the user. Accordingly, the identified NFT matching (corresponding to) the NFT managed (stored) in the theme database 321 may be an example of the predetermined condition. That is, for the NFT that is not managed (stored) in the theme database 321, the theme change cannot be performed even if the user possesses the NFT in the wallet address. Here, a common collection name may be assigned to multiple types of NFTs. Additionally, the ID of the NFT may be the token ID of the NFT, and in this case, the token ID is unique to the NFT.

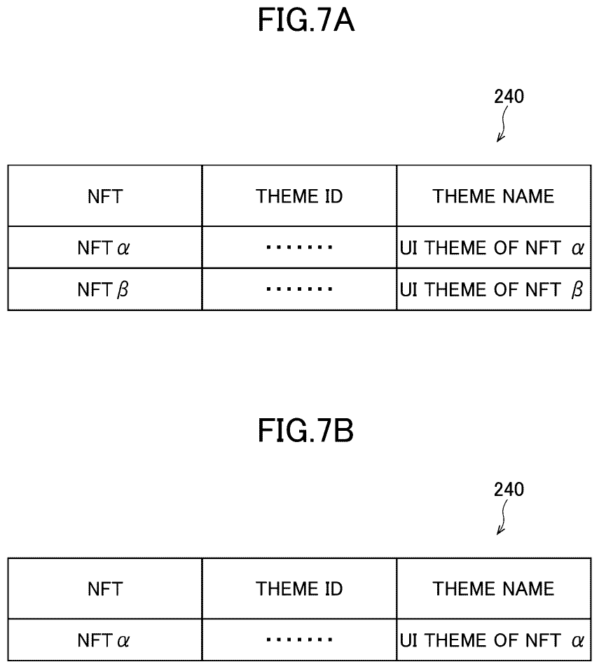

If there is no NFT with matching combinations of the contract address and the token ID, the theme management unit 331 determines that the theme information is not present in the NFT owned by the user (step S11: NO), and temporarily ends the process illustrated in FIG. 6. If there are one or more NFTs with matching combinations of the contract address and the token ID, the theme management unit 331 determines that the theme information is present in one or more NFTs owned by the user (step S11: YES). For example, if the user possesses the NFT possession information 320a illustrated in FIG. 4 and the theme database 321 stores the information illustrated in FIG. 5, the contract addresses and token IDs of the NFTs α and β in the possession information 320a match with contract addresses and token IDs in the theme database 321. In this case, the theme management unit 331 determines that the theme information is present in the NFTs α and β owned by the user. At this time, the theme management unit 331 creates selectable theme information 240 as illustrated in FIG. 7A and FIG. 7B (step S12). The selectable theme information 240 includes information on the theme ID, the theme name, and the like corresponding to the contract address and the token ID of the matched combination. For example, when the theme information is present in the NFTs α and β, the selectable theme information 240 includes information on the theme ID, the theme name, and the like corresponding to each of the NFTs α and β, as illustrated in FIG. 7A. Subsequently, as illustrated in FIG. 6, the theme management unit 331 transmits the created selectable theme information 240 to the terminal device 20 (step S13).

Here, when the user transfers the NFT β to another user or the like and no longer possesses the NFT β, the NFT possession information acquired by the theme management unit 331 from the user database 320 does not include information on the NFT β. In this case, the theme management unit 331 creates selectable theme information 240 as illustrated in FIG. 7B. The selectable theme information 240 illustrated in FIG. 7B includes only information on the theme ID, the theme name, and the like of the NFT α.

When receiving a transmission request of an NFT theme dataset transmitted from the terminal device 20, the theme management unit 331 reads the requested theme dataset from the theme database 321 and transmits the read theme dataset to the terminal device 20.

### (Configuration of the Terminal Device)

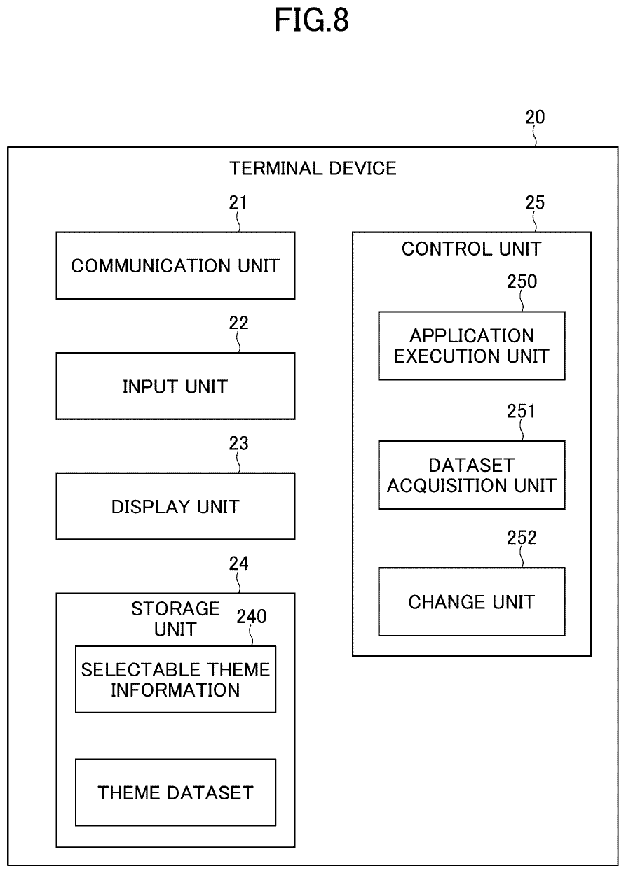

Next, a configuration of the terminal device 20 will be described. As illustrated in FIG. 8, the terminal device 20 includes a communication unit 21, an input unit 22, a display unit 23, a storage unit 24, and a control unit 25.

The communication unit 21 performs various communications with the server device 30 via the communication network N illustrated in FIG. 1. For example, the communication unit 21 transmits user operation information for the wallet application to the server device 30. Additionally, the communication unit 21 receives various types of information transmitted from the server device 30, such as possession information on the NFT and the virtual currency, the selectable theme information 240, the theme dataset, and the like.

The input unit 22 accepts user input operations, and is a mouse, a keyboard, or the like. The display unit 23 has a function of displaying various images, and is a liquid crystal display or the like. Here, in the following description, a case where the input unit 22 and the display unit 23 are configured by a touch panel in which such functions are integrated is described as an example.

The storage unit 24 stores various types of information held by the terminal device 20. For example, the storage unit 24 stores various types of program data for operating the terminal device 20. This program data includes program data for performing a wallet application. Additionally, the storage unit 24 stores the selectable theme information 240, the theme dataset, and the like.

The control unit 25 controls the terminal device 20. The control unit 25 includes an application execution unit 250, a dataset acquisition unit 251, and a change unit 252 as a functional configuration realized by executing the program data stored in the storage unit 24. The application execution unit 250 performs various processing related to the wallet application. For example, the application execution unit 250 performs processing for displaying, on the display unit 23, the possession information on the NFT and the virtual currency of the user transmitted from the server device 30. Additionally, when an operation related to the transaction of the NFT and the virtual currency is performed on the wallet application, the application execution unit 250 transmits, to the market management device 70, operation information corresponding to the transaction. With this, the market management device 70 performs various processing related to the transaction of the NFT and the virtual currency. Additionally, the application execution unit 250 acquires various types of information held by the market management device 70, such as the transaction history of NFT and the virtual currency.

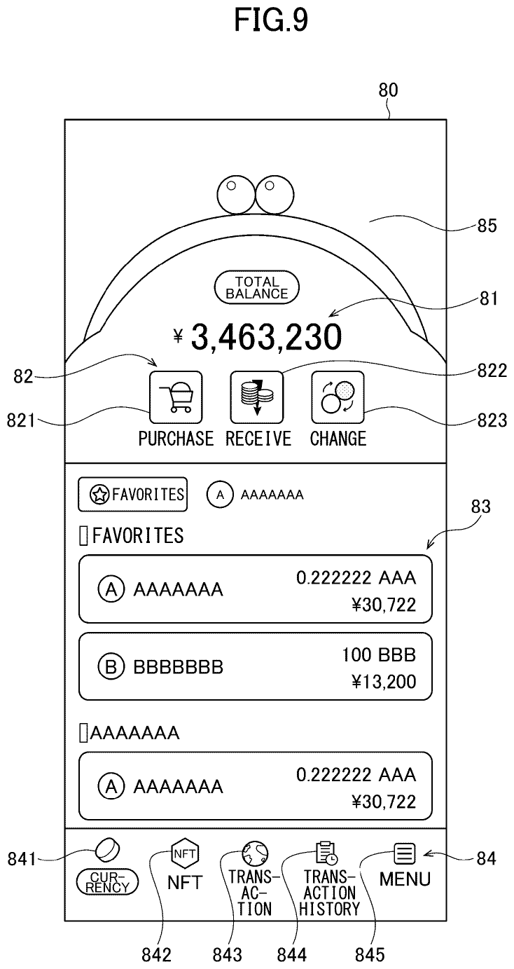

The dataset acquisition unit 251 acquires the UI theme dataset of the wallet application from the server device 30 by the communication unit 21. The change unit 252 performs processing for changing the UI of the wallet application. Specifically, the UI theme of the wallet application has a default theme that can be used regardless of the NFT possession status of the user. The change unit 252 sets the default theme as the UI theme of the wallet application in an initial state. FIG. 9 illustrates an example of an image 80 of the default theme displayed on the display unit 23.

As illustrated in FIG. 9, the image 80 of the default theme includes a balance display area 81, a first operation icon display area 82, a possession information display area 83, and a second operation icon display area 84. The balance display area 81 displays a legal tender equivalent value calculated by converting the total virtual currencies owned by the user.

In the first operation icon display area 82, icons 821 to 823 corresponding to various operations that can be performed by the user on the wallet application are displayed. By operating the icons 821 to 823, the user can make the wallet application perform processing corresponding to the operated icon.

In the background of the balance display area 81 and the first operation icon display area 82, a predetermined background image 85 is displayed. In the image 80 of the default theme illustrated in FIG. 9, an image of a clasp purse is displayed as the background image 85. In the possession information display area 83, information on the NFT, virtual currency, and the like owned by the user is displayed in a list. FIG. 9 exemplifies a case where information on multiple virtual currencies owned by the user is displayed in the possession information display area 83.

In the second operation icon display area 84, icons 841 to 845 corresponding to various operations that can be performed by the user on the wallet application are displayed. By operating the icon 841 or 842, the user can display the virtual currency or display the NFT in the possession information display area 83. By operating the icon 843, the user can perform various transactions of the NFT, the virtual currency, and the like. By operating the icon 844 or 845, the user can browse the transaction history of the NFT, the virtual currency, or the like, or display a menu screen. In the menu screen, for example, the UI theme of the wallet application can be changed.

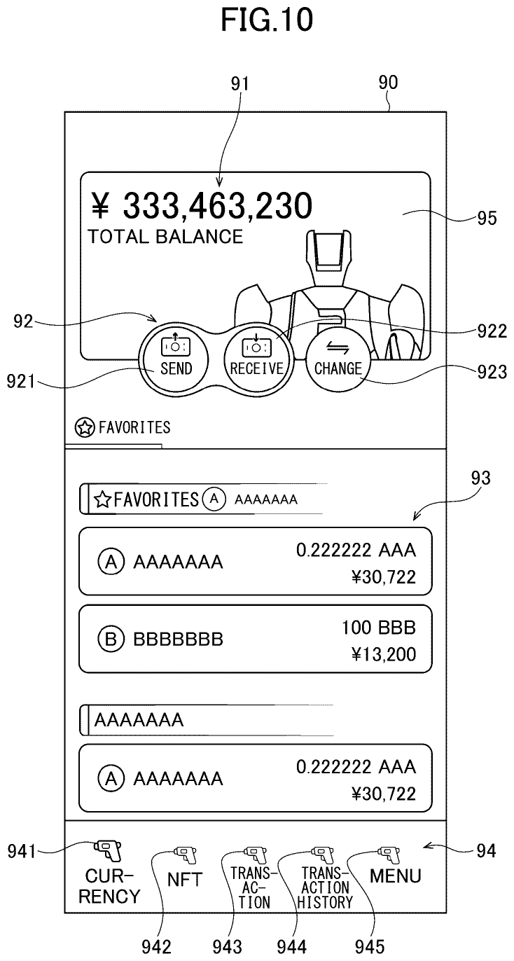

When an operation to change the UI theme is performed on the menu screen, the change unit 252 displays a name of a user-selectable theme on the display unit 23 based on the selectable theme information 240 stored in the storage unit 24. For example, when the selectable theme information 240 includes the information illustrated in FIG. 7A, the change unit 252 displays the name of the UI theme of NFT α and the name of the UI theme of NFT β on the display unit 23 as the name of the user-selectable theme. When the UI theme of NFT α is selected by the user, the dataset acquisition unit 251 acquires the theme dataset corresponding to the UI theme of NFT α from the server device 30. FIG. 10 illustrates an example of an image 90 of the UI theme of NFT α displayed on the display unit 23. As illustrated in FIG. 10, the image 90 of the UI theme of NFT α includes a balance display area 91, a first operation icon display area 92, a possession information display area 93, and a second operation icon display area 94 similarly to the default theme.

In the background of the balance display area 91 and the first operation icon display area 92 of the UI theme of NFT α, a background image 95 different from the background image 85 illustrated in FIG. 9 is displayed. In the image 90 of the UI theme of NFT α illustrated in FIG. 10, an image corresponding to NFT α is used as the background image 95. With respect to the color scheme and images of the icons 921 to 923 displayed in the first operation icon display area 92, the possession information display area 93, and the icons 941 to 945 displayed in the second operation icon display area 94, the color scheme and images corresponding to NFT α are used.

Here, when the user transfers NFT β to another user and the like, and no longer possesses NFT β, the content of selectable theme information 240 stored in the storage unit 24 is changed from the content illustrated in FIG. 7A to the content illustrated in FIG. 7B. In this case, when the icon 843 is operated by the user, the change unit 252 displays only the UI theme name of NFT α as the name of the user-selectable theme. When the UI theme dataset of NFT β is stored in the storage unit 24, the change unit 252 deletes the UI theme dataset of NFT β from the storage unit 24. As described, when the association of the NFT with the wallet address of the user is released, the change unit 252 deletes the theme name of the NFT whose association has been released, from the user-selectable theme names, thereby prohibiting the change to the UI theme corresponding to the NFT whose association has been released.

### (Operation Example of Information Processing System)

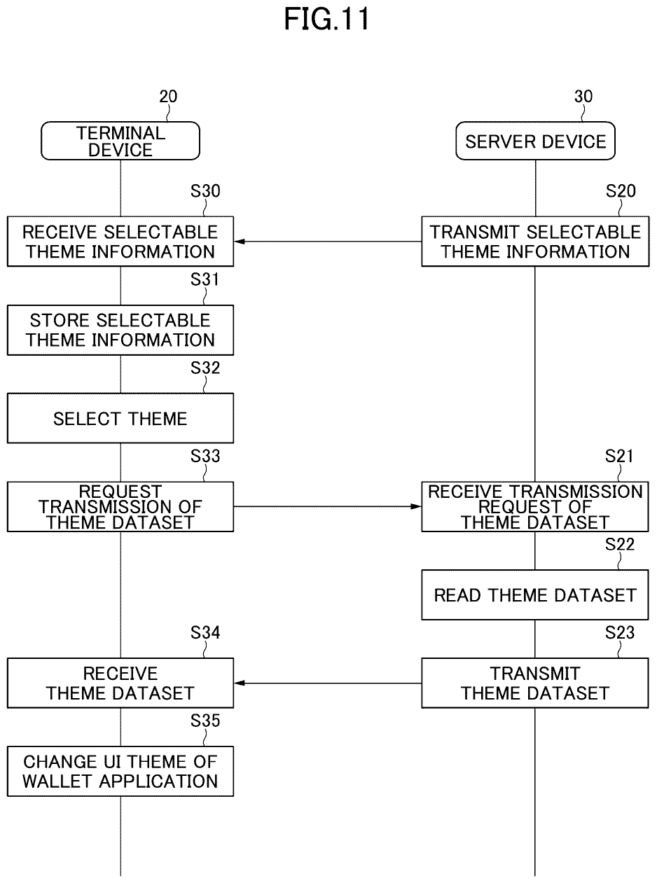

Next, an operation example of the information processing system 10 of the present embodiment will be described. As illustrated in FIG. 11, in the information processing system 10 of the present embodiment, first, the theme management unit 331 of the server device 30 transmits the selectable theme information 240 to the terminal device 20 by performing the process illustrated in FIG. 6 (step S20). In the terminal device 20, when the communication unit 21 receives the selectable theme information 240 transmitted from the server device 30 (step S30), the communication unit 21 causes the storage unit 24 to store the selectable theme information 240 (step S31).

Subsequently, when the user performs an operation to select one of the single or multiple NFT themes included in the selectable theme information 240 at the terminal device 20 (step S32), the change unit 252 requests the server device 30 to transmit the dataset of the selected NFT UI theme (step S33). In the server device 30, when the communication unit 31 receives the dataset transmission request transmitted from the terminal device 20 (step S21), the theme management unit 331 reads the requested theme dataset from the theme database 321 (step S22) and transmits the read theme dataset to the terminal device 20 (step S23).

Subsequently, in the terminal device 20, when the communication unit 21 receives the theme dataset transmitted from the server device 30 (step S34), the change unit 252 performs the change of the UI theme of the wallet application based on the received theme dataset (step S35).

### (Hardware Configuration of Information Processing System)

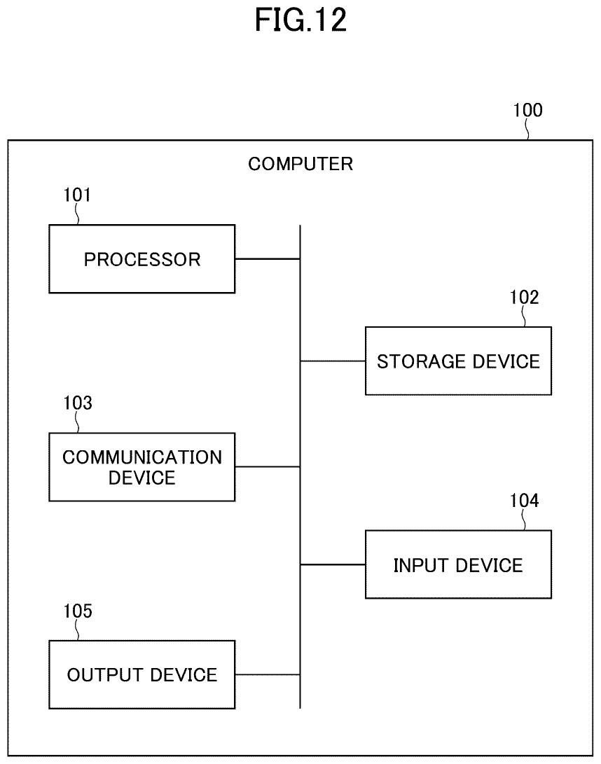

Next, an example of a hardware configuration of a computer 100 when the terminal device 20 and the server device 30 are implemented by the computer 100 will be described with reference to FIG. 12.

As illustrated in FIG. 12, the computer 100 includes a processor 101, a storage device 102, a communication device 103, an input device 104, an output device 105, and the like. The processor 101 is a central processing unit (CPU), a graphical processing unit (GPU), and the like. The storage device 102 includes, for example, at least one of a memory, a hard disk drive (HDD), or a solid state drive (SSD). The communication device 103 performs wired or wireless communication. The input device 104 accepts input operations and includes, for example, at least one of a keyboard, a touch panel, a mouse, or a microphone. The output device 105 outputs information and includes, for example, at least one of a display, a touch panel, or a speaker.

### (Operation and Effect of Information Processing System)

As described above, the information processing system 10 of the present embodiment includes the theme management unit 331 (the information acquisition unit) and the change unit 252. The theme management unit 331 acquires the information on the NFT associated with the wallet address of the user. The change unit 252 changes the UI of the wallet application available to the user to a UI corresponding to the NFT associated with the wallet address of the user. According to this configuration, when the user possesses a predetermined NFT, the UI of the wallet application of the user can be changed to a UI corresponding to the predetermined NFT owned by the user. Therefore, the UI of the wallet application can be more appropriately changed based on the NFT.

The change unit 252 performs a theme change for changing the UI theme of the wallet application to a theme corresponding to the NFT associated with the wallet application of the user. According to this configuration, when the theme change is performed, the atmosphere of the whole wallet application including the background image, icons, and the like is changed to an atmosphere corresponding to the NFT owned by the user, thereby easily increasing the user's interest in the UI theme change.

When multiple NFTs are associated with the wallet address of the user, the change unit 252 performs a theme change using a theme selected by the user among multiple UI themes corresponding to multiple NFTs satisfying a predetermined condition. The predetermined condition is that, for example, the combination of the contract address and the token ID of the NFT owned by the user matches the combination of the contract address and the token ID registered in the theme database 321. According to this configuration, the theme change corresponding to the NFT owned by the user can be appropriately performed.

The information processing system 10 of the present embodiment further includes the dataset acquisition unit 251. The dataset acquisition unit 251 acquires, from the server device 30, the UI theme dataset corresponding to the NFT associated with the wallet address of the user. The change unit 252 changes the UI of the application available to the user based on the UI theme dataset acquired from the server device 30. According to this configuration, the UI of the application can be easily changed.

When the association of the NFT with the wallet address of the user is released, the change unit 252 deletes the theme name of the NFT whose association has been released, from the user-selectable theme names, thereby preventing the change of the UI theme corresponding to the NFT whose association has been released. According to this configuration, when the NFT once owned by the user is transferred to another user, the situation in which the theme of the NFT is continuously available can be avoided, and a more appropriate theme can be used according to the actual possession state of the NFT of the user.

### (Modified Example)

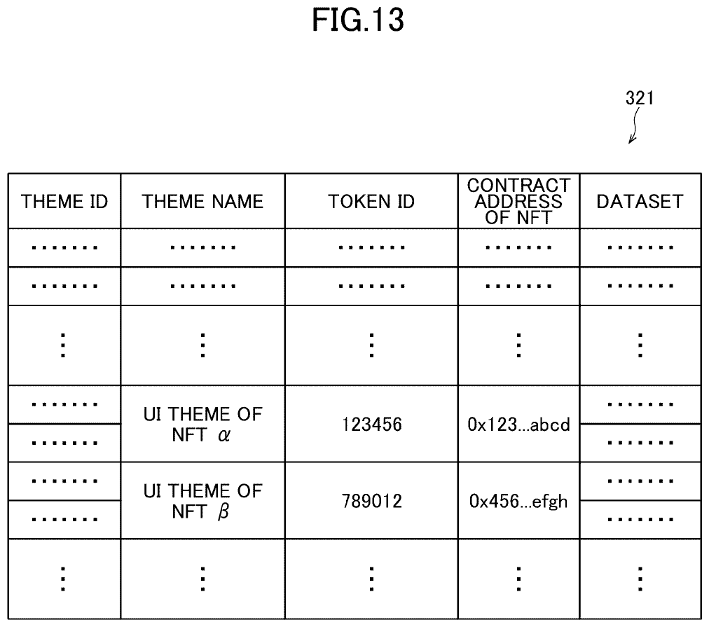

Next, an information processing system 10 according to a modified example of the first embodiment will be described. In the information processing system 10 according to the first embodiment, as illustrated in FIG. 5, one theme dataset is associated with one NFT. Alternatively, as illustrated in FIG. 13, multiple UI theme datasets may be associated with one NFT, for example. Here, the multiple UI theme datasets associated with one NFT differ in at least one of font information, layout information, image data, image data arrangement information, or color palette information. In this case, the dataset acquisition unit 251 may change the UI theme of the wallet application to the theme dataset selected by the user among the multiple theme datasets associated with one NFT.

### Second Embodiment

Next, an information processing system of the second embodiment will be described. In the following, differences from the information processing system of the first embodiment will be mainly described.

### (Schematic Structure of Information Processing System)

In the information processing system 10 of the first embodiment, the UI theme dataset of the NFT is stored in the server device 30. Instead, the information processing system 10 of the present embodiment is different in that the UI theme dataset of the NFT is stored in the metadata of the NFT and a theme data management device 110. That is, the theme change (the user interface change) can be performed by using the metadata of the NFT.

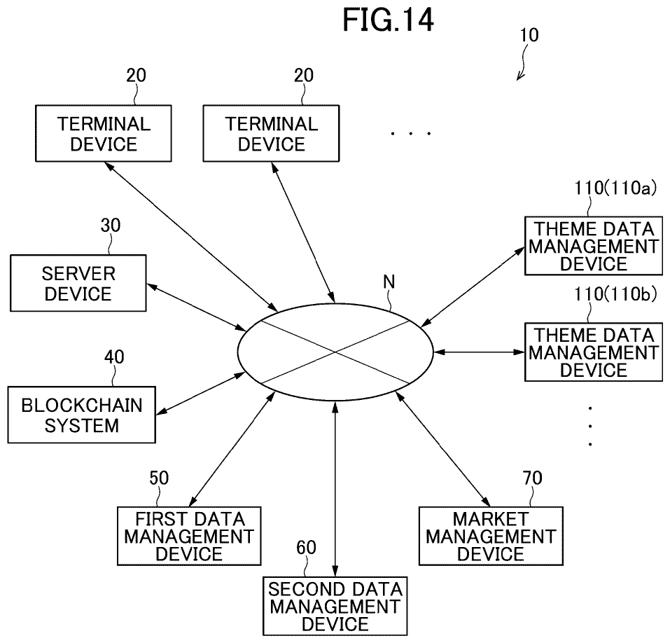

Specifically, as illustrated in FIG. 14, the information processing system 10 further includes multiple theme data management devices 110. Each of the theme data management devices 110 is connected to the communication network N. Each of the theme data management devices 110 stores image data used for the background, icon, and the like of the wallet application in the UI theme dataset of the NFT. Each of the theme data management devices 110 stores image data corresponding to each of the multiple NFTs. For example, a theme data management device 110a stores image data corresponding to NFT α. A theme data management device 110b stores image data corresponding to NFT β. Here, the image data of all NFTs may be stored in one theme data management device 110.

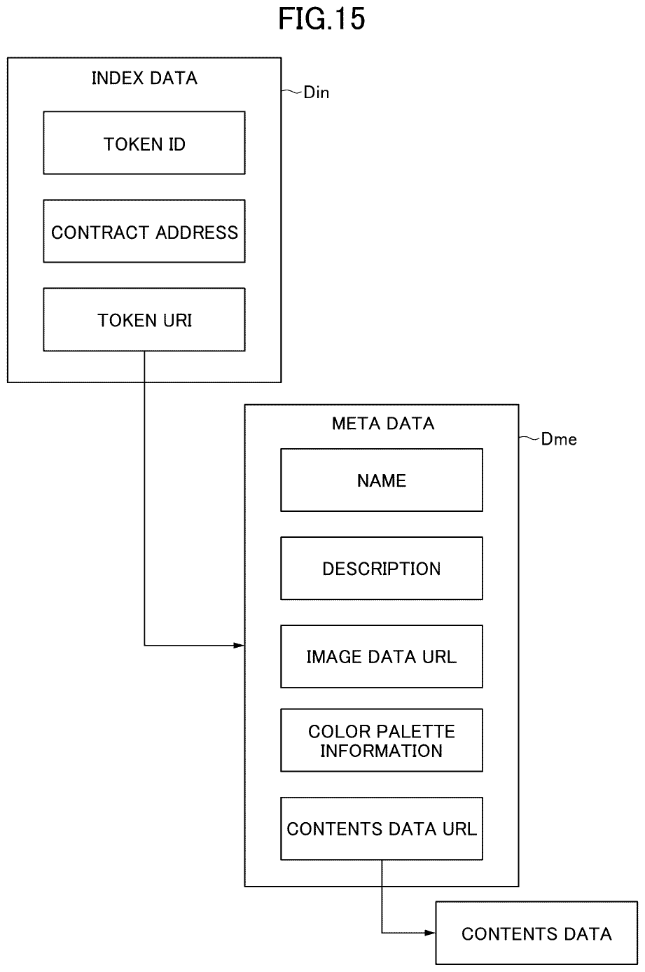

As illustrated in FIG. 15, the metadata Dme of the NFT further includes a URL of image data, color palette information, and the like. The URL of the image data is the URL of the download of the image used for the background, icon, and the like of the wallet application. For example, the URL of the image data stored in the theme data management device 110a is used as the URL of the link of the image data of NFT α. Additionally, the URL of the image data stored in the theme data management device 110b is used as the URL of the link of the image data of NFT β. The color palette information specifies RGB information and the like of a text included in the UI theme.

When the user performs an operation to select one of multiple selectable NFT UI themes, the dataset acquisition unit 251 of the present embodiment acquires information on the selected NFT UI theme from the metadata Dme of the NFT and the theme data management device 110. For example, when the user performs an operation to select the UI theme of NFT α, the dataset acquisition unit 251 acquires the metadata Dme of NFT α from the server device 30. Here, the dataset acquisition unit 251 may acquire the metadata Dme of NFT α from the server device 30 at the time when the user possesses the NFT α, for example, and store it in the storage unit 24 in advance. The dataset acquisition unit 251 acquires the URL of the image data and the color palette information from the metadata Dme of NFT α acquired from the server device 30. Additionally, the dataset acquisition unit 251 acquires the image data used for the background, icon, and the like of the wallet application from the theme data management device 110a based on the URL of the image data included in the metadata Dme.

The change unit 252 changes the UI of the wallet application based on the image data used for the background, icon, and the like of the wallet application acquired from the theme data management device 110 by the dataset acquisition unit 251, and based on the color palette information and the like acquired from the metadata Dme by the dataset acquisition unit 251. Additionally, the theme change (the user interface change) may be performed by using the metadata of the NFT as follows. The information processing system identifies the ID included in the metadata of the NFT associated with the wallet address of the user, and determines whether the identified ID matches (corresponds to) the ID of the NFT managed in the theme database. When the information processing system determines that the IDs match, the performance of the theme change (the user interface change) may be allowed. Here, as described above, the theme change (the user interface change) is performed in response to the user's operation on the wallet application. Specifically, the change can be performed, for example, by downloading the theme (the user interface) corresponding to the designated NFT from the theme database in response to the user's operation.

### (Operation and Effect of Information Processing System)

As described above, in the information processing system 10 of the present embodiment, the metadata Dme of the NFT includes the information on the UI corresponding to the NFT. The dataset acquisition unit 251 acquires the information on the UI theme corresponding to the NFT from the metadata Dme of the NFT associated with the wallet address. The change unit 252 changes the UI theme of the wallet application available to the user, based on the information on the UI theme acquired by the dataset acquisition unit 251. According to this configuration, it is not necessary to provide the theme database 321 in the server device 30, so that the configuration of the server device 30 can be simplified. Usually, UI customization (UI change) information corresponding to a user's identified NFT can be retrieved (downloaded) from a server and implemented. The present disclosure enables the use of image data included in metadata of an NFT for a part of design after customization (customized UI). This allows for a unique customization design (NFT-specific UI) on an NFT-by-NFT basis rather than on a collection basis.

### Other Embodiments

The present disclosure is not limited to the above specific examples. For example, the UI theme change of the wallet application is not limited to changing the background image and icon of the wallet application, but it may also include changing the format of text or the like displayed in the wallet application. As the UI theme change of the wallet application, the change unit 252 may also change the sound, music, or the like emitted from the wallet application.

The change unit 252 is not limited to changing the UI theme of the wallet application, that is, changing the whole wallet application, but it may also include changing only the icon of the wallet application, or changing only the background image of the wallet application. The application whose UI can be changed is not limited to the wallet application, but may also be any application available to the user in the terminal device 20, such as a game application or a social media application.

The functional configuration of each of the terminal device 20 and the server device 30 may be provided only in the terminal device 20, only in the server device 30, or in each of the terminal device 20 and the server device 30. For example, the theme management unit 331 of the server device 30 may be provided in the terminal device 20.

The above-described specific examples with appropriate design changes made by a person skilled in the art are also included in the scope of the present disclosure as long as they have the features of the present disclosure. The elements provided in the above-described specific examples, the arrangement, conditions, shapes, and the like thereof are not limited to those illustrated in the examples, and may be appropriately changed. The elements provided in the above-described specific examples may be appropriately changed in combination as long as there is no technical inconsistency.

What is claimed is:

1. A non-transitory computer-readable recording medium having stored therein a program for causing a computer to perform:
acquiring, through a wallet application used by a user and configured to manage a non-fungible token, information on the non-fungible token associated with a wallet address of the user;
determining whether a predetermined condition is satisfied based on the acquired information on the non-fungible token; and
changing a user interface of the wallet application to a user interface corresponding to the non-fungible token according to an operation of the user in response to determining that the predetermined condition is satisfied.

2. The non-transitory computer-readable recording medium having stored the program as claimed in claim 1, the program causing the computer to refer to a storage unit configured to store the user interface corresponding to the non-fungible token,
wherein the computer determines that the predetermined condition is satisfied in response to determining that information on the user interface corresponding to the information on the non-fungible token associated with the wallet address is stored in the storage unit.

3. The non-transitory computer-readable recording medium having stored the program as claimed in claim 2, wherein the wallet application is configured to manage a cryptographic asset associated with the wallet address.

4. The non-transitory computer-readable recording medium having stored the program as claimed in claim 1, wherein the changing of the user interface includes performing theme change of changing a theme of the wallet application to a theme corresponding to the non-fungible token associated with the wallet address.

5. The non-transitory computer-readable recording medium having stored the program as claimed in claim 4, wherein the performing of the theme change includes performing the theme change using a theme selected by the user among a plurality of themes corresponding to a plurality of non-fungible tokens that satisfy the predetermined condition, the plurality of non-fungible tokens being associated with the wallet address.

6. The non-transitory computer-readable recording medium having stored the program as claimed in claim 4, wherein the theme change includes a change in at least one of a background image, an icon, or a text format of the wallet application.

7. The non-transitory computer-readable recording medium having stored the program as claimed in claim 1, the program causing the computer to perform:
acquiring, from a server device, information on the user interface corresponding to the non-fungible token associated with the wallet address; and
changing the user interface of the wallet application based on the information on the user interface acquired from the server device.

8. A non-transitory computer-readable recording medium having stored therein a program for causing a computer to perform:
acquiring, through a wallet application used by a user and configured to manage a non-fungible token, information on the non-fungible token associated with a wallet address of the user, the information on the non-fungible token including metadata;
acquiring information on a user interface corresponding to the non-fungible token by using the metadata; and
changing a user interface of the wallet application based on the acquired information on the user interface.

9. The non-transitory computer-readable recording medium having stored the program as claimed in claim 1, the program causing the computer to perform:
preventing the user interface of the wallet application from changing to a user interface corresponding to a released non-fungible token, the released non-fungible token being not associated with the wallet address.

10. The non-transitory computer-readable recording medium having stored the program as claimed in claim 1,
wherein only one piece of information on the user interface corresponding to the non-fungible token is associated with the non-fungible token, and
wherein the program causes the computer to change the user interface of the wallet application to the user interface of the one piece of information associated with the non-fungible token.

11. The non-transitory computer-readable recording medium having stored the program as claimed in claim 1,
wherein a plurality of pieces of information on the user interface corresponding to the non-fungible token are associated with the non-fungible token, and
wherein the program causes the computer to change the user interface of the wallet application to the user interface of one of the plurality of pieces of information associated with the non-fungible token.

12. An information processing system comprising
a memory; and
a processor that is coupled to the memory and configured to:
acquire, through a wallet application used by a user and configured to manage a non-fungible token, information on the non-fungible token associated with a wallet address of the user;
determine whether a predetermined condition is satisfied based on the acquired information on the non-fungible token; and
change a user interface of the wallet application to a user interface corresponding to the non-fungible token according to an operation of the user in response to determining that the predetermined condition is satisfied.
